(19) United States
(12) Patent Application Publication
(10) Pub. No.: US 2018/0077757 A1
(43) Pub. Date: Mar. 15, 2018

(54) BEVERAGE HEATING SYSTEM

(71) Applicants: Mark Goodosn, Corinth, TX (US); Christian Goodson, Corinth, TX (US)

(72) Inventors: Mark Goodosn, Corinth, TX (US); Christian Goodson, Corinth, TX (US)

(21) Appl. No.: 15/454,302

(22) Filed: Mar. 9, 2017

Related U.S. Application Data
(60) Provisional application No. 62/393,021, filed on Sep. 10, 2016.

(51) Int. Cl. H05B 3/68; H02J 7/02; H02J 50/10; H01F 38/14

(52) U.S. Cl. CPC H05B 3/68; H02J 7/025; H05B 2203/021; H01F 38/14; H02J 50/10

(57) ABSTRACT

A system having a beverage coaster with a receiving coil that can be magnetically coupled or decoupled from a driving coil in a counter table, bar and the like. The coaster may be magnetically coupled to the table by moving the coaster into an area where the driving coil generates a magnetic field of sufficient strength. The coaster has a metallic plate on which may be positioned a beverage container. The plate is thermally and mechanically coupled to a power resistor that heats the plate and thus the beverage container.

### CROSS REFERENCE TO RELATED APPLICATIONS

This application further claims benefit under 35 USC 119 and incorporates by reference United States Provisional Application by inventors Mark E Goodson and Christian R. Goodson, filed electronically with the USPTO on Sep. 10, 2016 with a serial number of 62/393,021 and EFS ID 26888862 confirmation number 8586.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the USPTO patent file or records, but otherwise reserves all copyright rights whatsoever.

### FIELD OF THE INVENTION

The present invention generally applies to temperature control of a beverage. More specifically, the present invention relates to temperature heating and cooling of an already served beverage.

Drinks that are served in a restaurant are usually cooled or heated, with many beverages being cooled by ice. Some drinks, such as coffee and cocoa, are enjoyed while being served hot or warm. The laws of heat transfer mandate that over time thermal gain or loss of the beverage will continue until the beverage reaches room temperature (thermal equilibria). Drinks that are cold will usually have ice melt due to heat gain, while drinks served warm or hot will have a heat loss and thus they cool off.

Some issued patents make use of heating and cooling of a glass, cup or similar vessel. Senecal (U.S. Pat. No. 5,718,124), for example, teaches the refrigeration of a service bowl, with the refrigeration circuitry being part of the bowl. Similarly, Alexander (U.S. Pat. Nos. 8,759,721 and 9,035,222) teach the use of heated or cooled beverage holders where the circuitry that is providing the temperature change is part of the glassware or serving dishes. Simcray (U.S. Pat. No. 6,279,470) teaches the use of vessel that has an armature as part of the plate or food holder; this same patent, however, does not teach the use of a coaster that can accommodate various cooking vessels that may already be owned by the user.

### BRIEF SUMMARY OF THE INVENTION

The present invention provides a number of advantages over existing art. For example, the present invention allows the heating of a beverage holder (e.g., a cup or glass) without the necessity of that beverage holder containing any circuitry or specially designed components.

Structurally, the present invention comprises a beverage coaster having a first end, an opposing second end, a housing, a non-corrosive metallic plate connected to the housing at the first end, a resistive heating element within the housing mechanically and thermally connected to the metallic plate, a receiving coil located within the housing proximal to the second end, and coaster circuitry electrically connected to the resistive heating element, and the receiving coil; and a counter or table with a top surface and a bottom surface, a driving coil, and driver circuitry connected to the driving coil.

### BRIEF DESCRIPTION OF THE DRAWINGS

FIG. 1 shows an embodiment of the present invention.

FIG. 2 is a schematic of the coaster circuitry of the embodiment.

FIG. 3 is a schematic of the driver circuitry of the embodiment.

### DESCRIPTION OF SPECIFIC EMBODIMENTS

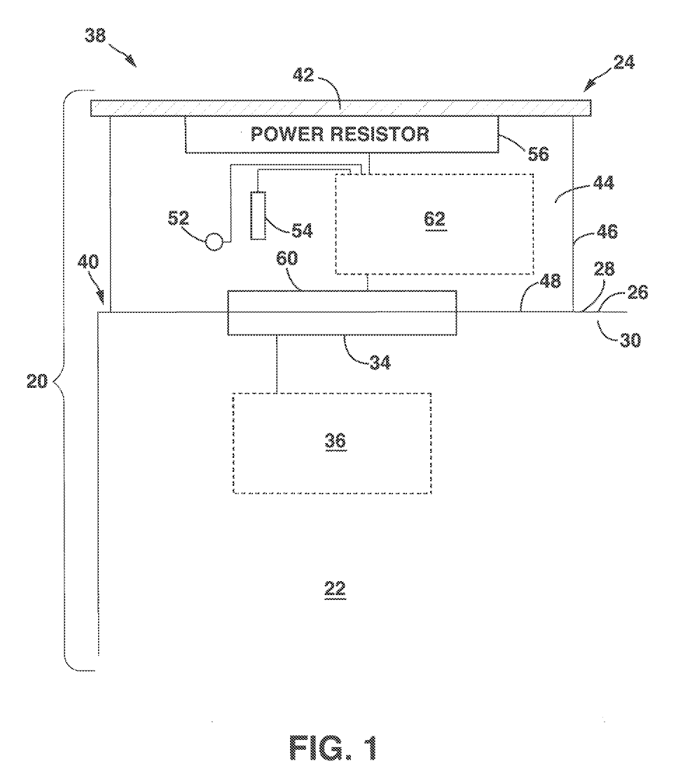

FIG. 1 shows an embodiment 20 of the invention, which includes a counter 22 and a beverage coaster 24. The counter 22 includes a countertop 26 with a top surface 28 and a bottom surface 30, an inductive driving coil 34, and driver circuitry 36 electrically connected to the coil 34. The inductive driving coil 34, and driver circuitry 36 are adjacent to the bottom surface 30 of the countertop 26. While this embodiment 20 contemplates the driving coil 34 and driver circuitry 36 being adjacent the countertop, alternatively, they can be inset as part of the countertop 26. Although this embodiment 20 is described specifically with reference to a countertop, other embodiments contemplate the invention include a table, bar top, and the like.

The coaster 24 is generally a closed cylinder with a first end 38 and a second end 40. The second end 40 contacts the countertop 26 opposite the driver circuitry 36. The coaster 24 is made of a solid cylindrical copper plate 42 attached to a hollow cylindrical plastic housing 44 with a sidewall 46 and a closed end 48 coterminal with the second end 40. A blue LED 52, and a USB port 54 are mounted to the sidewall 46. Copper is preferred because of its resistance to corrosion and for its coefficient of thermal conductivity, but other metals may be used.

The housing 44 encloses a power resistor 56, a receiving coil 60, and coaster circuitry 62. The power resistor 56 is mechanically and thermally connected to the copper plate 42. The thermal connection is enhanced with the use of thermally conducting grease (not shown) between the power resistor 56 and the copper plate 42. The receiving coil 60 is located proximal to the closed end 48 and is vertically aligned with the driving coil 34. The coaster circuity 62 electrically connects the LED 52, the USB port 54, and the power resistor 56.

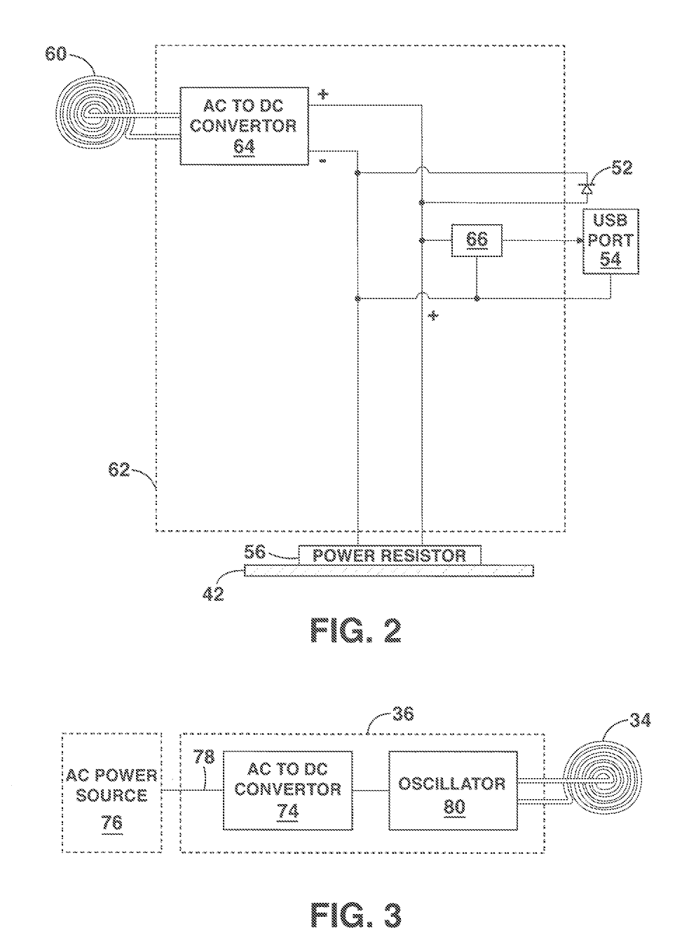

Referring to FIG. 2, the coaster circuity 62 includes an AC-to-DC converter 64 connected to the receiving coil 60, and a voltage regulator 66 connected to the USB port 54. The regulator 66 is a standard 3-lead 5-volt regulator that provides power to the USB port 54, allowing the coaster 24 to also serve as a means for charging a phone or operating a game. This configuration causes the power resistor 56 to generate heat at the connection with the copper plate 42. The blue LED 53 is energized whenever the receiving coil 60 is energized, indicating that the driving coil 34 is magnetically coupled to said receiving coil 60.

Referring to FIG. 3, the driver circuitry 36 includes an AC-to-DC converter 74 connectable to an AC input source 76 (nominal 120 VAC 60 Hz) with a line cord 78. The converter 74 rectifies and filters the signal from the input source 76. The output of the converter 74 is connected to a 100 KHz oscillator 80 that generates a square wave. The output of the oscillator 80 is connected to the driving coil 34. The driver circuitry 36 is enclosed so it is protected from mechanical damage (e.g., spills, mechanical cuts from serving utensils).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim the following:

1. A beverage heating system comprising:
A beverage coaster having a first end, an opposing second end, a metallic plate connected to the first end, a power resistor within the housing that is mechanically and thermally connected to the metallic plate, a receiving coil located within the housing proximal to the second end, and coaster circuitry electrically connected to the power resistor and the receiving coil, and
A counter with a countertop having a top surface and bottom surface, a driving coil, and driver circuitry connected to the driving coil

2. The system of claim 1, wherein the driving coil is magnetically coupled to the receiving coil

3. The system of claim 1 further comprising driver circuitry electrically connected to the driving coil.

4. The system of claim 1 further comprising coaster circuitry electrically connected to the receiving coil and the power resistor.

5. The system of claim 1 further comprising a USB port mounted to the housing and electrically connected to the coaster circuitry.

6. The system of claim 1 further comprising an AC to DC converter connected to the receiving coil.
